(19) United States
(12) Patent Application Publication
(10) Pub. No.: US 2023/0239623 A1
(43) Pub. Date: Jul. 27, 2023

(54) FPCB Diaphragm Microspeaker Having Magnetic Field Pair Structure

(71) Applicant: EM-TECH Co., Ltd., Gyeongsangnam-do (KR)

(72) Inventor: Byung Min Yu, Seoul (KR)

(21) Appl. No.: 18/098,186

(22) Filed: Jan. 18, 2023

(30) Foreign Application Priority Data
Jan. 24, 2022 (KR) 10-2022-0010033

(51) Int. Cl. H04R 9/02; H04R 7/02

(52) U.S. Cl. CPC H04R 9/025; H04R 7/02

(57) ABSTRACT

The present disclosure relates to a flexible printed circuit board (FPCB) diaphragm microspeaker having a magnetic field pair structure, and more particularly, to a microspeaker using an FPCB diaphragm in which magnetic fields are arranged in pairs up and down to increase the strength of a horizontal component of the magnetic fields. The microspeaker includes: a FPCB diaphragm in which a conductive coil pattern is formed on a non-conductive film; an upper magnetic circuit disposed above the FPCB diaphragm and having a yoke and a magnet; and a lower magnetic circuit disposed below the FPCB diaphragm and having a yoke and a magnet. When an electrical signal is applied to the coil pattern of the FPCB diaphragm, the FPCB diaphragm vibrates to generate sound by mutual electromagnetic force between the upper magnetic circuit and the lower magnetic circuit.

### TECHNICAL FIELD

The present disclosure relates to a flexible printed circuit board (FPCB) diaphragm microspeaker having a magnetic field pair structure, and more particularly, to a microspeaker using an FPCB diaphragm in which magnetic fields are arranged in pairs up and down to increase the strength of a horizontal component of the magnetic fields.

### BACKGROUND

As true wireless stereo (TWS) technology has developed for user convenience, earphones require a more compact structure. In addition, as sound devices become prevalent, users desire a higher sound quality level, and thus, higher performance and higher quality sound characteristics are required for sound devices.

In general, a microspeaker using a dynamic structure adopts a voice coil that generates mutual electromagnetic force with a magnetic circuit to convert an electrical signal into a physical movement and a diaphragm, on which the voice coil is attached, to transform the physical movement into sound. However, since the relatively heavy voice coil is attached to the thin, light diaphragm, a weight of an vibrating system increases and a response speed decreases, which causes deterioration in performance during high-pitched sound reproduction.

Therefore, an FPCB diaphragm structure capable of reducing the weight of the vibrating system and improving sound reproduction performance has been attempted. An FPCB diaphragm does not use a heavy voice coil and may be used to replace a coil structure and a diaphragm, and therefore, the weight of the vibrating system may be reduced, and in particular, performance of a speaker in a high-pitched range may be improved. However, an improved structure is required to obtain sufficient speaker power as much as that of a dynamic structure of the related art.

### SUMMARY

An aspect of the present disclosure is to provide a microspeaker employing a flexible printed circuit board (FPCB) to replace a diaphragm and a voice coil to reduce a weight of a vibrating system, thereby improving high-pitched sound reproduction performance.

Another aspect of the present disclosure is to provide a microspeaker in which magnetic fields are configured above and below an FPCB diaphragm to achieve stronger power.

According to an aspect of the present disclosure, there is provided a microspeaker including: a flexible printed circuit board (FPCB) diaphragm in which a conductive coil pattern is formed on a non-conductive film; an upper magnetic circuit disposed above the FPCB diaphragm and having a yoke and a magnet; and a lower magnetic circuit disposed below the FPCB diaphragm and having a yoke and a magnet, wherein, when an electrical signal is applied to the coil pattern of the FPCB diaphragm, the FPCB diaphragm vibrates to generate sound by mutual electromagnetic force between the upper magnetic circuit and the lower magnetic circuit.

In addition, in the microspeaker according to embodiments of the present disclosure, the upper magnetic circuit may include an upper first magnet and an upper second magnet maintaining a predetermined distance, the lower magnetic circuit may include a lower first magnet and a lower second magnet maintaining a predetermined distance, and a shape and arrangement of the upper first magnet and the upper second magnet and a shape and arrangement of the lower first magnet and the lower second magnet may be symmetrical to each other with the FPCB diaphragm therebetween.

In addition, in the microspeaker according to embodiments of the present disclosure, the conductive coil pattern of the FPCB diaphragm may include a first pattern concentration portion formed to be close to an edge of the first magnet adjacent to the second magnet of the upper magnetic circuit or lower magnetic circuit, and a second pattern concentration portion formed to be close to an edge of the second magnet adjacent to the first magnet of the upper magnetic circuit or lower magnetic circuit.

In addition, in the microspeaker according to embodiments of the present disclosure, the conductive coil pattern may be formed as multiple layers on upper and lower surfaces of the non-conductive film.

In addition, in the microspeaker according to embodiments of the present disclosure, the conductive coil pattern may be formed on one surface of the FPCB diaphragm, and an auxiliary diaphragm for increasing rigidity of the FPCB diaphragm may be attached to the other surface of the FPCB diaphragm.

In addition, in the microspeaker according to embodiments of the present disclosure, the auxiliary diaphragm may be formed of a metal material having a density of 7 g/cm³ or less and a thickness of 0.1 mm or less.

In addition, in the microspeaker according to embodiments of the present disclosure, an upper damper may be disposed between the upper magnetic circuit and the FPCB diaphragm to maintain a constant distance therebetween, and a lower damper may be disposed between the lower magnetic circuit and the FPCB diaphragm to maintain a constant distance therebetween.

In the FPCB diaphragm microspeaker having a magnetic field pair structure according to the present disclosure, magnetic fields are formed symmetrically up and down, unlike the related art in which a magnetic field is formed on only one side, thereby increasing the strength of a horizontal component of the magnetic field to improve power of the speaker.

In addition, in the FPCB diaphragm microspeaker having a magnetic field pair structure according to the present disclosure, an electrical pattern of an FPCB diaphragm is efficiently concentrated on an area in which the magnetic field may be concentrated, thereby improving power of the speaker, compared with the related art FPCB diaphragm.

In addition, the FPCB diaphragm microspeaker having a magnetic field pair structure according to the present disclosure additionally includes an auxiliary diaphragm formed of a high elasticity and low density material, thereby increasing rigidity of the FPCB diaphragm and enabling stable sound reproduction even at ultra-high frequencies.

### BRIEF DESCRIPTION OF THE DRAWINGS

FIG. 1 is an exploded perspective view of a microspeaker according to a first embodiment of the present disclosure;

FIG. 2 is a perspective view of a microspeaker according to the first embodiment of the present disclosure;

FIG. 3 is an upper view of a flexible printed circuit board (FPCB) diaphragm according to the first embodiment of the present disclosure;

FIG. 4 is a cross-sectional view of a microspeaker according to the first embodiment of the present disclosure;

FIG. 5 is a graph showing a magnetic flux density (a) of a magnetic circuit of the related art and a graph showing a magnetic flux density (b) of a symmetrical magnetic circuit of the first embodiment of the present disclosure;

FIG. 6 is a cross-sectional view of a microspeaker according to a second embodiment of the present disclosure;

FIG. 7 is a lower view of an FPCB diaphragm according to the second embodiment of the present disclosure;

FIG. 8 is an exploded perspective view of a microspeaker according to a third embodiment of the present disclosure; and

FIG. 9 is a cross-sectional view of a microspeaker according to the third embodiment of the present disclosure.

### DETAILED DESCRIPTION

Hereinafter, the present disclosure will be described in more detail with reference to the drawings.

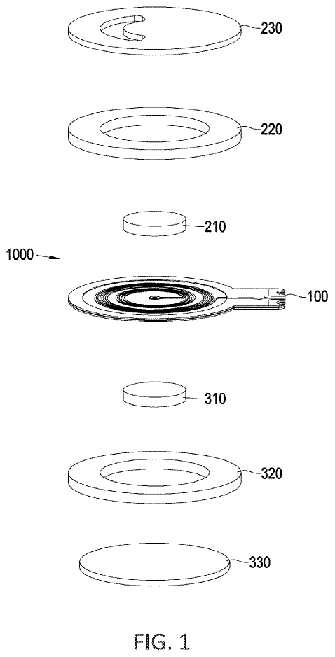

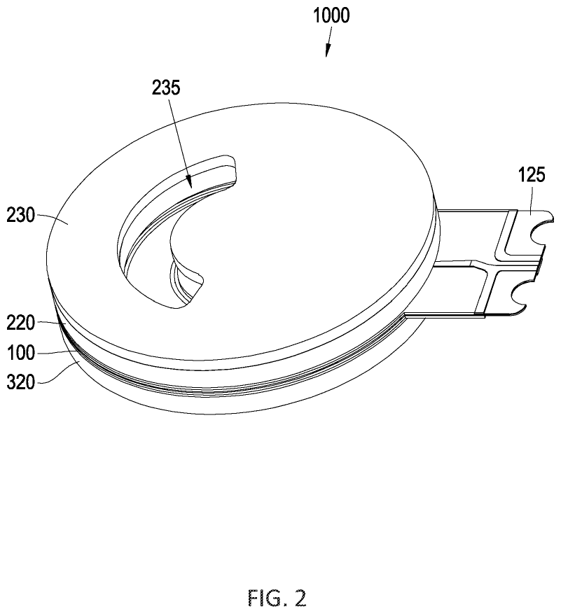

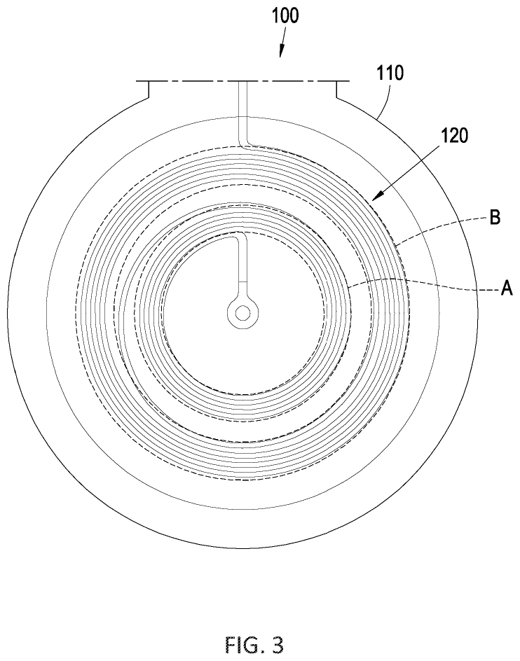

FIG. 1 is an exploded perspective view of a microspeaker 1000 according to a first embodiment of the present disclosure, FIG. 2 is a perspective view of the microspeaker 1000 according to the first embodiment, and FIG. 3 is an upper view of a flexible printed circuit board (FPCB) diaphragm 100 according to the first embodiment. In the microspeaker 1000 of the present embodiment, a lower yoke 330 at the bottom and a lower first magnet 310 and a lower second magnet 320 seated on the lower yoke 330 form a lower magnetic circuit for sound reproduction. The FPCB diaphragm 100 is seated thereon. Thereabove, an upper first magnet 210 and an upper second magnet 220 are seated and an upper yoke 230 is seated at the top, forming an upper magnetic circuit. In the present embodiment, the yokes 230 and 330, the first magnets 210 and 310, the second magnets 220 and 320, and the FPCB diaphragm 100 all have a circular outer shape, but this is only an example, and these components may also have a quadrangular or any other outer shapes. The FPCB diaphragm 100 to be described below may be provided with a conductive coil pattern, so that when an electrical signal is applied, at least one side of the FPCB diaphragm 100 may vibrate up and down to generate sound by mutual electromagnetic force between the upper magnetic circuit formed by the upper first magnet 210 and the upper second magnet 220 and the upper yoke 230 and the lower magnetic circuit formed by the lower first magnet 310 and the lower second magnet 320 and the lower yoke 330.

The FPCB diaphragm 100 has a disk shape in which a conductive coil pattern 120 is formed on a non-conductive film 110. In the FPCB diaphragm 100, the conductive coil pattern 120 formed of a highly conductive material, such as Cu, Al, Au, and Ag is formed on the non-conductive film 110 formed of a polymer compound, such as polyamide, PET film, PEEK, elastomer, and silicone rubber. In addition, a terminal 125 transmitting an electrical signal to the conductive coil pattern 120 may be provided.

The upper first magnet 210 and the upper second magnet 220 are disposed to be spaced apart from each other at a predetermined interval to form a magnetic circuit, and the upper yoke 230 is seated thereon to complete the upper magnetic circuit. The lower first magnet 310 and the lower second magnet 320 are also disposed to be spaced apart from each other at a predetermined interval to form a magnetic circuit, and the two magnets are seated on the lower yoke 330 to complete the lower magnetic circuit. The magnets 210, 220, 310 and 320 are preferably permanent magnets. The microspeaker 1000 of the present embodiment may include a sound emission outlet 235 that may be formed by removing one side of the upper yoke 230. Of course, as another embodiment, the sound emission outlet 235 may also be formed by removing one side of the lower yoke 330.

In the present disclosure, the shape and arrangement of the upper first magnet 210 and the upper second magnet 220 and the shape and arrangement of the lower first magnet 310 and the lower second magnet 320 are symmetrical with each other with the FPCB diaphragm 100 therebetween. With this arrangement, a magnetic field formed by the upper magnetic circuit and a magnetic field formed by the lower magnetic circuit are perfectly symmetrical based on a position in which the FPCB diaphragm 100 is placed, and as horizontal components thereof completely overlap each other, the strength about doubles.

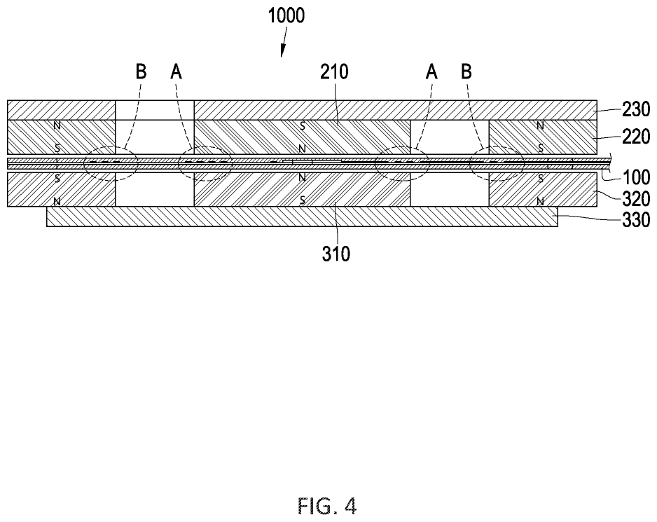

FIG. 4 is a cross-sectional view of the microspeaker 1000 according to the first embodiment of the present disclosure. As shown in FIGS. 3 and 4, in the present embodiment, the conductive coil pattern 120 of the FPCB diaphragm 100 is concentrated and formed in an edge portion in which the upper first magnet 210 and the upper second magnet 220 face each other at a predetermined interval or in an edge portion in which the lower first magnet 310 and the lower second magnet 320 face each other at a predetermined interval. That is, a first pattern concentration portion A may be formed as the conductive coil pattern is concentrated to be formed close to the edges of the first magnets 210 and 310 adjacent to the second magnets 220 and 320 among the upper magnetic circuit and the lower magnetic circuit. In addition, a second pattern concentration portion B may be formed as the conductive coil pattern is concentrated to be formed close to the edges of the second magnets 220 and 320 adjacent to the first magnets 210 and 310 among the upper magnetic circuit and the lower magnetic circuit. When the conductive coil pattern 120 of the FPCB diaphragm 100 includes the first pattern concentration portion A and the second pattern concentration portion B formed to be adjacent to the edge of each magnet, the conductive coil pattern 120 may be concentrated to a region in which the magnetic fields formed with the magnets 210, 220, 310, and 320 are concentrated, and therefore, mutual electromagnetic force may be more efficiently increased, compared to the conductive coil pattern of the related art arranged without the pattern concentration portions A and B, thereby increasing power of the microspeaker 1000.

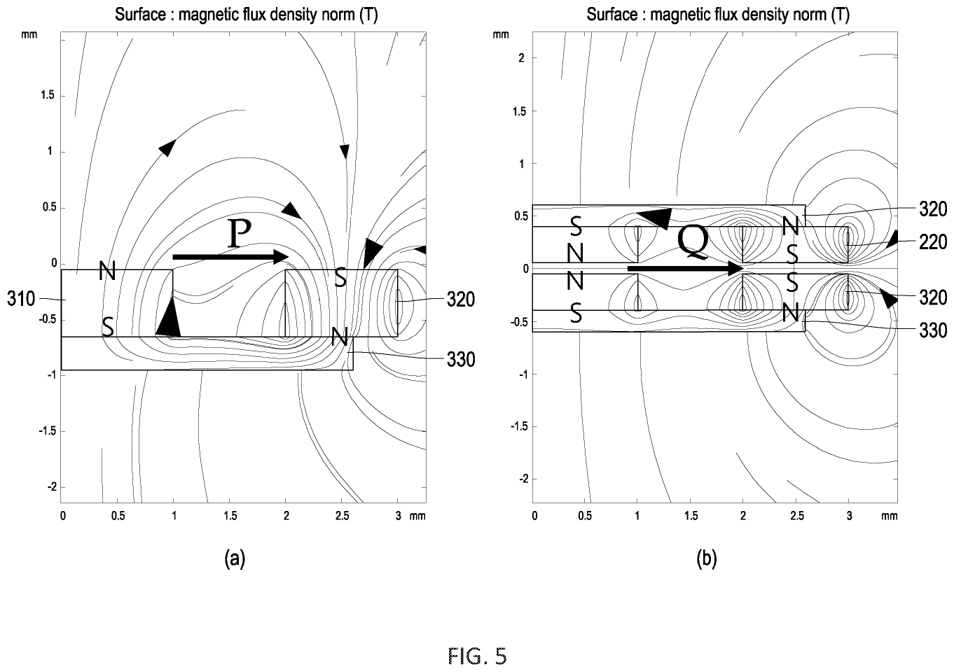

FIG. 5 is a graph showing a comparison between a magnetic flux density (a) when only one magnetic circuit, that is, only a lower magnetic circuit is configured as in the related art, and a magnetic flux density (b) when the upper and lower magnetic circuits are symmetrically configured as in the first embodiment of the present disclosure. In the case (b) in which the upper and lower magnetic circuits are symmetrically configured as in the first embodiment of the present disclosure (b), upper and lower magnetic fields overlap each other at the position of the FPCB diaphragm 100, which is the center of symmetry, and a horizontal component Q is strengthened, resulting in an increase in mutual electromagnetic force with the FPCB diaphragm 100, so the power of the microspeaker 1000 increases. In the case (a) in which only the lower magnetic circuit is configured, there is no such overlap, so a horizontal component P of the magnetic field is smaller than the horizontal component Q in the case of overlapping.

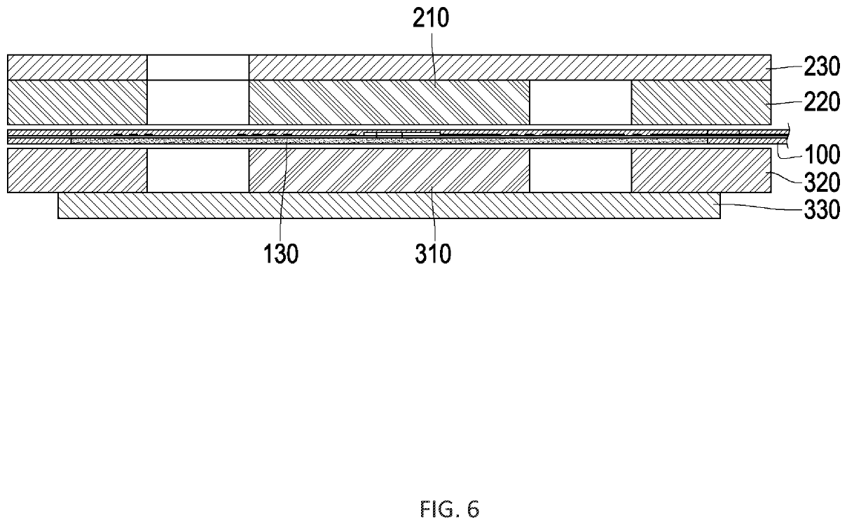

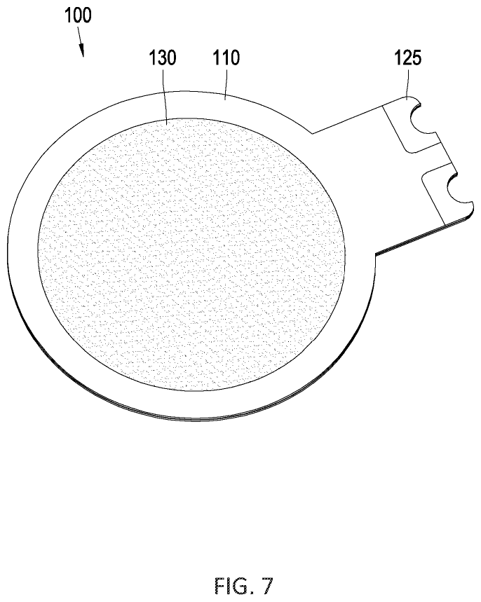

FIG. 6 is a cross-sectional view of the microspeaker 1000 according to a second embodiment of the present disclosure, and FIG. 7 is a bottom view of the FPCB diaphragm 100 according to the second embodiment of the present disclosure. The present embodiment differs from the first embodiment in an auxiliary diaphragm 130 for increasing rigidity of the FPCB diaphragm 100 is further provided. In the present embodiment, preferably, the conductive coil pattern 120 of the FPCB diaphragm 100 is provided only on an upper surface of the non-conductive film 110, and the auxiliary diaphragm 130 is attached on a lower surface of the non-conductive film 110 on which the conductive coil pattern 120 is not formed. The auxiliary diaphragm 130 is preferably formed of a material having high elasticity and low density, and particularly, preferably formed of a metal material having a density of 7 g/cm³ or less and a thickness of 0.1 mm or less. The FPCB diaphragm 100 has a disadvantage that the rigidity is not high compared to the diaphragm structure of the related art. In the case of having the auxiliary diaphragm 130 formed of a high elasticity and low density material as in the present embodiment, the rigidity of the FPCB diaphragm 100 may be supplemented, so that stable vibration may be ensured even in an ultra-high range, and reproducibility of sound in the ultra-high range may be improved.

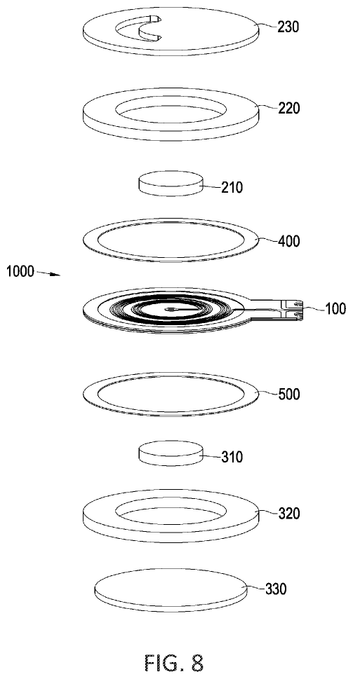

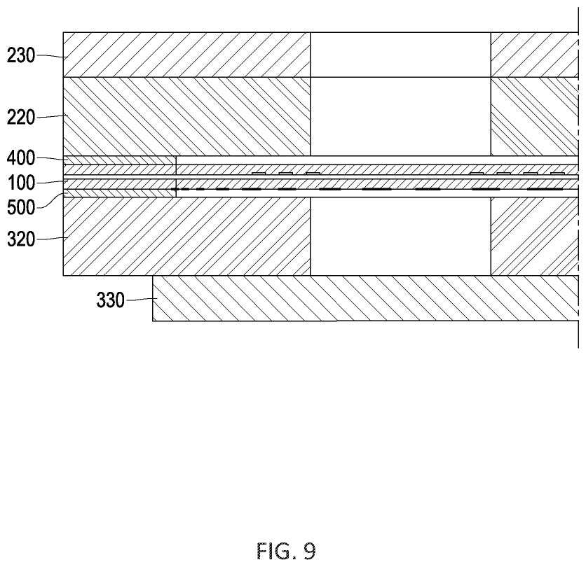

FIG. 8 is an exploded perspective view of the microspeaker 1000 according to a third embodiment of the present disclosure, and FIG. 9 is a cross-sectional view of the microspeaker 1000 according to the third embodiment. Compared to the first embodiment, the third embodiment further includes an upper damper 400 and a lower damper 500 for maintaining a constant distance between the upper and lower magnetic circuits and the FPCB diaphragm 100. That is, the upper second magnet 220 is seated on the FPCB diaphragm 100 with the ring-shaped upper damper 400 therebetween, and the lower second magnet 320 is seated on the FPCB diaphragm 100 with the ring-shaped lower damper 500 therebetween. The dampers 400 and 500 maintain a constant distance between the FPCB diaphragm 100 and the upper and lower magnetic circuits so that the FPCB diaphragm 100 may vibrate smoothly without interference with the upper or lower magnetic circuit component.

While the present disclosure has been shown and described in connection with the embodiments, it will be apparent to those skilled in the art that modifications and variations may be made without departing from the spirit and scope of the invention as defined by the appended claims.

What is claimed is:

1. A microspeaker comprising:
a flexible printed circuit board (FPCB) diaphragm in which a conductive coil pattern is formed on a non-conductive film;
an upper magnetic circuit disposed above the FPCB diaphragm and having a yoke and a magnet; and
a lower magnetic circuit disposed below the FPCB diaphragm and having a yoke and a magnet,
wherein, when an electrical signal is applied to the conductive coil pattern of the FPCB diaphragm, the FPCB diaphragm vibrates to generate sound by mutual electromagnetic force between the upper magnetic circuit and the lower magnetic circuit.

2. The microspeaker of claim 1, wherein:
the upper magnetic circuit includes an upper first magnet and an upper second magnet maintaining a predetermined distance;
the lower magnetic circuit includes a lower first magnet and a lower second magnet maintaining a predetermined distance; and
a shape and arrangement of the upper first magnet and the upper second magnet and a shape and arrangement of the lower first magnet and the lower second magnet are symmetrical to each other with the FPCB diaphragm therebetween.

3. The microspeaker of claim 2, wherein the conductive coil pattern of the FPCB diaphragm includes a first pattern concentration portion formed to be close to an edge of the first magnet adjacent to the second magnet of the upper magnetic circuit or lower magnetic circuit, and a second pattern concentration portion formed to be close to an edge of the second magnet adjacent to the first magnet of the upper magnetic circuit or lower magnetic circuit.

4. The microspeaker of claim 1, wherein the conductive coil pattern is formed as multiple layers on upper and lower surfaces of the non-conductive film.

5. The microspeaker of claim 1, wherein the conductive coil pattern is formed on one surface of the FPCB diaphragm, and an auxiliary diaphragm for increasing rigidity of the FPCB diaphragm is attached to another surface of the FPCB diaphragm.

6. The microspeaker of claim 5, wherein the auxiliary diaphragm is formed of a metal material having a density of 7 g/cm³ or less and a thickness of 0.1 mm or less.

7. The microspeaker of claim 1, wherein an upper damper is disposed between the upper magnetic circuit and the FPCB diaphragm to maintain a constant distance therebetween, and a lower damper is disposed between the lower magnetic circuit and the FPCB diaphragm to maintain a constant distance therebetween.
